(19) United States
(12) Patent Application Publication
(10) Pub. No.: US 2024/0372299 A1
(43) Pub. Date: Nov. 7, 2024

(54) ELECTRICAL CONNECTION ASSEMBLY WITH RADIO-FREQUENCY IDENTIFICATION TAG VERIFICATION SYSTEM

(71) Applicant: Oetiker NY, Inc., Lancaster, NY (US)

(72) Inventors: Kari Ann Sausen, Clarence, NY (US); James Anthony Kujawski, JR., Attica, NY (US); Kristian James Hagen, Gasport, NY (US)

(21) Appl. No.: 18/650,310

(22) Filed: Apr. 30, 2024

Related U.S. Application Data
(60) Provisional application No. 63/499,997, filed on May 4, 2023.

(51) Int. Cl. H01R 13/641; H01R 13/629; H01R 13/66

(52) U.S. Cl. CPC H01R 13/641; H01R 13/62938; H01R 13/6691

(57) ABSTRACT

An electrical connection assembly including a first connector including an engaging portion, a first surface including a plurality of sockets, and a first plurality of wires connected to the plurality of sockets, a second connector including a plurality of terminals, and a second plurality of wires connected to the plurality of terminals, a radio-frequency identification (RFID) assembly connected to one of the first connector and the second connector, and a locking handle operatively arranged to lock the second connector to the first connector, wherein in an unconnected state the locking handle is not engaged with the RFID assembly, and in a connected state the locking handle is engaged with the RFID assembly.

### CROSS-REFERENCE TO RELATED APPLICATIONS

This application claims the benefit under 35 U.S.C. § 119(e) of U.S. Provisional Patent Application No. 63/499,997, filed May 4, 2023, which application is incorporated herein by reference in its entirety.

### FIELD

The present disclosure relates to electrical connectors, and more particularly, to a electrical connection assembly including a radio-frequency identification (RFID) tag to verify connection.

### BACKGROUND

An electrical connector is an electromechanical device used to create an electrical connection between parts of an electrical circuit, or between different electrical circuits, thereby joining them into a larger circuit. Most electrical connectors have a gender (i.e., the male component, called a plug, connects to the female component, or socket). The connection may be removable (as for portable equipment), require a tool for assembly and removal, or serve as a permanent electrical joint between two points. An adapter can be used to join dissimilar connectors. Electrical connectors may be used not only for power applications, but also for data and audiovisual applications.

In automotive applications, a wire harness junction block or electrical connection assembly is used to connect different circuits (e.g., ignition system including the starter, dash lights, gauges, radio, tail lights, wipers, turn signals, heat, air conditioning, electrical fuel pump, etc.) to a power source or power sources. However, current designs are difficult to connect and failure to properly connect such electrical connection assemblies can lead to a no start condition on the vehicle.

### SUMMARY

The present disclosure is directed to one or more exemplary embodiments of an electrical connection assembly that provides verification that an electrical connection assembly is properly connected.

The present disclosure is directed to one or more exemplary embodiments of an electrical connection assembly.

In an exemplary embodiment, the electrical connection assembly comprises a first connector including an engaging portion, a first surface comprising a plurality of sockets, and a first plurality of wires connected to the plurality of sockets, a second connector including a plurality of terminals, and a second plurality of wires connected to the plurality of terminals, a radio-frequency identification (RFID) assembly connected to one of the first connector and the second connector, and a locking handle operatively arranged to lock the second connector to the first connector, wherein in an unconnected state the locking handle is not engaged with the RFID assembly, and in a connected state the locking handle is engaged with the RFID assembly.

In an exemplary embodiment, the RFID assembly comprises a RFID tag and at least one contact electrically connected to the RFID tag. In an exemplary embodiment, the at least one contact comprises a first contact and a second contact, the second contact separated from the first contact to form an open state of the RFID assembly. In an exemplary embodiment, in the connected state, the first contact is electrically connected to the second contact.

In an exemplary embodiment, the locking handle comprises a conductive contact assembly operatively arranged to, in the connected state, electrically connect the first contact to the second contact. In an exemplary embodiment, the conductive contact assembly comprises a conductor at least partially circumscribing the locking handle. In an exemplary embodiment, the conductive contact further comprises a tab extending radially outward from the conductor. In an exemplary embodiment, the conductive contact assembly comprises a first conductor portion extending radially outward from the locking handle and operatively arranged to engage the first contact, and a second conductor portion extending radially outward from the locking handle and operatively arranged to engage the second contact. In an exemplary embodiment, the conductive contact assembly further comprises a third conductor portion connecting the first conductor portion and the second conducting portion, the third conductor portion being embedded in the locking handle. In an exemplary embodiment, at least one of the first conductor portion and the second conductor portion comprises a cylindrical rod. In an exemplary embodiment, at least one of the first conductor portion and the second conductor portion comprises a curvilinear tab.

In an exemplary embodiment, the first connector comprises a first surface and a flange extending from the first surface, the RFID tag is arranged on the first surface, and the at least one contact is arranged on the flange. In an exemplary embodiment, the flange is perpendicular to the first surface. In an exemplary embodiment, the RFID assembly is arranged on the first connector, and the locking handle is pivotably connected to the second connector. In an exemplary embodiment, the RFID tag comprises an antenna, in an open state of the RFID tag, the antenna circuit is open, and in a closed state of the RFID tag, the antenna circuit is closed.

The present disclosure is directed to one or more exemplary embodiments of an electrical connection assembly.

In an exemplary embodiment, the electrical connection assembly comprises a first connector including an engaging portion, a first surface comprising a plurality of sockets, and a first plurality of wires connected to the plurality of sockets, a second connector including a hole operatively arranged to engage the engaging portion, a plurality of terminals, and a second plurality of wires connected to the plurality of terminals, a radio-frequency identification (RFID) assembly connected to one of the first connector and the second connector, the RFID assembly comprising a RFID tag, a first contact electrically connected to the RFID tag, and a second contact electrically connected to the RFID tag and spaced apart from the first contact, and a locking handle pivotably connected to the other of the first connector and the second connector, the locking handle operatively arranged to lock the second connector to the first connector, wherein in an unconnected state the locking handle is not engaged with the first contact and the second contact, and in a connected state the locking handle is engaged with the first contact and the second contact.

In an exemplary embodiment, the locking handle comprises a conductive contact assembly operatively arranged to, in the connected state, electrically connect the first contact to the second contact. In an exemplary embodiment, the conductive contact assembly comprises a conductor at least partially circumscribing the locking handle. In an exemplary embodiment, the conductive contact further comprises a tab extending radially outward from the conductor. In an exemplary embodiment, the conductive contact assembly comprises a first conductor portion extending radially outward from the locking handle and operatively arranged to engage the first contact, and a second conductor portion extending radially outward from the locking handle and operatively arranged to engage the second contact. In an exemplary embodiment, the conductive contact assembly further comprises a third conductor portion connecting the first conductor portion and the second conducting portion, the third conductor portion being embedded in the locking handle.

The present disclosure is directed to one or more exemplary embodiments of an electrical connection assembly, for example, an electrical junction box for an automobile. The junction box comprises a female component and a male component. In an exemplary embodiment, the female component comprises a locking handle. The male component is engaged with the female component, at which point the locking handle is pulled down over the male component. In an exemplary embodiment, the handle is part of the female component; although, the handle may alternatively be part of the male component. The male component has a flange and a RFID tag is arranged proximate the flange, with electrical terminals arranged on or near the flange. The handle has a conductor element such that, once fully in the locked position, the conductor element contacts both electrical terminal completing the RFID tag circuit, thus changing the RFID tag from reading “open” to reading “closed.” The “open” reading indicates an unlocked or unconnected state, and the “closed” reading indicates a locked or a connected state.

The present disclosure is directed to one or more exemplary embodiments of a wire harness junction block assembly that provides positive identification that a locking handle thereof has been fully closed during the production assembly process, thereby indicating a proper or full connection. In an exemplary embodiment, the wire harness junction block assembly comprises a RFID tag that indicates a first state (e.g., off signal) when the handle is not fully closed and a second state (e.g., on signal) when the handle is fully closed.

In an exemplary embodiment, the electrical connection assembly provides the user with a positive identification for correct closure of a wire harness junction black, which, for example, prevents a no start condition on a vehicle. In an exemplary embodiment, the electrical connection assembly provides a feedback signal (e.g., via a RFID tag) to indicate the state and a change in state, which can be read by a user or by a computer program. In the case of a computer program, the electrical connection assembly removes the need for human interaction to detect the state of the connection. In an exemplary embodiment, the RFID tag is arranged on the junction box housing and when the locking handle contacts terminals of the RFID tag, the circuit of the RFID tag is closed or completed (i.e., indicating a connected state of the electrical connection assembly). If the locking handle is not in contact with the terminals of the RFID tag, the circuit of the RFID tag is open (i.e., indicating an unconnected state of the electrical connection assembly). In an exemplary embodiment, the RFID tag reads “open” when the locking handle is not in a fully closed position, and the RFID tag reads “closed” when the locking handle is in a fully closed position.

These and other objects, features, and advantages of the present disclosure will become readily apparent upon a review of the following detailed description of the disclosure, in view of the drawings and appended claims.

### BRIEF DESCRIPTION OF THE DRAWINGS

The accompanying drawings are incorporated herein as part of the specification. The drawings described herein illustrate embodiments of the presently disclosed subject matter and are illustrative of selected principles and teachings of the present disclosure, in which corresponding reference symbols indicate corresponding parts. However, the drawings do not illustrate all possible implementations of the presently disclosed subject matter and are not intended to limit the scope of the present disclosure in any way.

FIG. 1A is a front perspective view of an electrical connection assembly in an unconnected state.

FIG. 1B is a front elevational view of the electrical connection assembly shown in FIG. 1A, in an unconnected state.

FIG. 1C is a front perspective view of the electrical connection assembly shown in FIG. 1A, in a connected state.

FIG. 2 is an exploded front perspective view of the electrical connection assembly shown in FIG. 1A.

FIG. 3A is a rear elevational view of the first connector shown in FIG. 1A.

FIG. 3B is a side elevational view of the first connector shown in FIG. 1A.

FIG. 4 is a perspective view of the RFID tag shown in FIG. 1A.

FIG. 5A is a front perspective view of the second connector shown in FIG. 1A, with the locking handle in a retracted position.

FIG. 5B is a front perspective view of the second connector shown in FIG. 1A, with the locking handle in a deployed position.

FIG. 6 is a partial front perspective view of an electrical connection assembly, in a connected state.

FIG. 7 is a detail view of the electrical connection assembly taken generally along Detail 7 in FIG. 6.

FIG. 8 is a partial front perspective view of an electrical connection assembly, in a connected state.

FIG. 9 is a detail view of the electrical connection assembly taken generally along Detail 9 in FIG. 8.

FIG. 10 is a partial front perspective view of an electrical connection assembly, in a connected state.

FIG. 11 is a detail view of the electrical connection assembly taken generally along Detail 11 in FIG. 10.

### DETAILED DESCRIPTION

It is to be understood that the invention may assume various alternative orientations and step sequences, except where expressly specified to the contrary. It is also to be understood that the specific assemblies and systems illustrated in the attached drawings and described in the following specification are simply exemplary embodiments of the inventive concepts defined herein. Hence, specific dimensions, directions, or other physical characteristics relating to the embodiments disclosed are not to be considered as limiting, unless expressly stated otherwise. Also, although they may not be, like elements in various embodiments described herein may be commonly referred to with like reference numerals within this section of the application.

Furthermore, it is understood that this disclosure is not limited to the particular methodology, materials and modifications described and as such may, of course, vary. It is also understood that the terminology used herein is for the purpose of describing particular aspects only, and is not intended to limit the scope of the claims.

Unless defined otherwise, all technical and scientific terms used herein have the same meaning as commonly understood to one of ordinary skill in the art to which this disclosure pertains. It should be understood that any methods, devices or materials similar or equivalent to those described herein can be used in the practice or testing of the example embodiments.

Where used herein, the terms “first,” “second,” and so on, do not necessarily denote any ordinal, sequential, or priority relation, but are simply used to more clearly distinguish one element or set of elements from another, unless specified otherwise.

Where used herein, the term “about” when applied to a value is intended to mean within the tolerance range of the equipment used to produce the value, or, in some examples, is intended to mean plus or minus 10%, or plus or minus 5%, or plus or minus 1%, unless otherwise expressly specified.

It should be appreciated that the term “substantially” is synonymous with terms such as “nearly,” “very nearly,” “about,” “approximately,” “around,” “bordering on,” “close to,” “essentially,” “in the neighborhood of,” “in the vicinity of,” etc., and such terms may be used interchangeably as appearing in the specification and claims. It should be appreciated that the term “proximate” is synonymous with terms such as “nearby,” “close,” “adjacent,” “neighboring,” “immediate,” “adjoining,” etc., and such terms may be used interchangeably as appearing in the specification and claims. The term “substantially” is intended to mean values within ten percent of the specified value.

Where used herein, the term “exemplary” is intended to mean “an example of,” “serving as an example,” or “illustrative,” and does not denote any preference or requirement with respect to a disclosed aspect or embodiment.

It should be understood that use of “or” in the present application is with respect to a “non-exclusive” arrangement, unless stated otherwise. For example, when saying that “item x is A or B,” it is understood that this can mean one of the following: (1) item x is only one or the other of A and B; (2) item x is both A and B. Alternately stated, the word “or” is not used to define an “exclusive or” arrangement. For example, an “exclusive or” arrangement for the statement “item x is A or B” would require that x can be only one of A and B. Furthermore, as used herein, “and/or” is intended to mean a grammatical conjunction used to indicate that one or more of the elements or conditions recited may be included or occur. For example, a device comprising a first element, a second element and/or a third element, is intended to be construed as any one of the following structural arrangements: a device comprising a first element; a device comprising a second element; a device comprising a third element; a device comprising a first element and a second element; a device comprising a first element and a third element; a device comprising a first element, a second element and a third element; or a device comprising a second element and a third element.

Moreover, as used herein, the phrases “comprises at least one of” and “comprising at least one of” in combination with a system or element is intended to mean that the system or element includes one or more of the elements listed after the phrase. For example, a device comprising at least one of: a first element; a second element; and a third element, is intended to be construed as any one of the following structural arrangements: a device comprising a first element; a device comprising a second element; a device comprising a third element; a device comprising a first element and a second element; a device comprising a first element and a third element; a device comprising a first element, a second element and a third element; or a device comprising a second element and a third element. A similar interpretation is intended when the phrase “used in at least one of:” is used herein.

It should be appreciated that the term “tube” as used herein is synonymous with hose, pipe, channel, conduit, tube end form, or any other suitable pipe flow used in hydraulics and fluid mechanics. It should further be appreciated that the term “tube” can mean a rigid or flexible conduit of any material suitable for containing and allowing the flow of a gas or a liquid.

The terms unconnected state and connected state as used herein refer to the position and arrangement of the male and female connectors, and their respective wires. In the unconnected state, the male and female connectors are not fully connected and power and data is not transferred through their respective wires. The terms retracted position and deployed position as used herein refer to the position and arrangement of the locking handle.

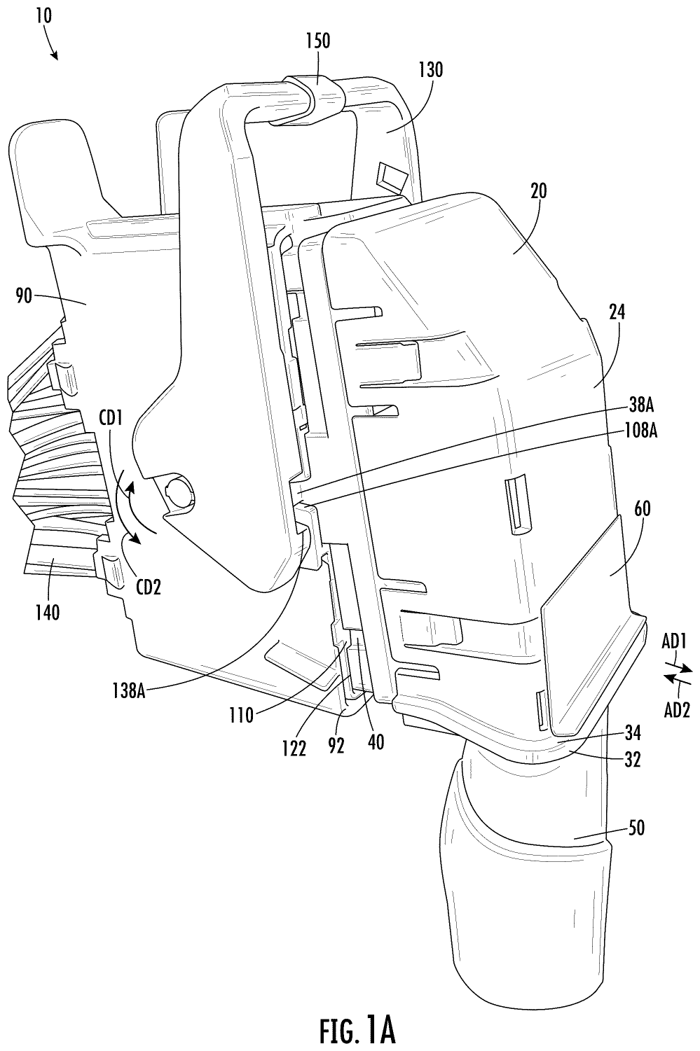

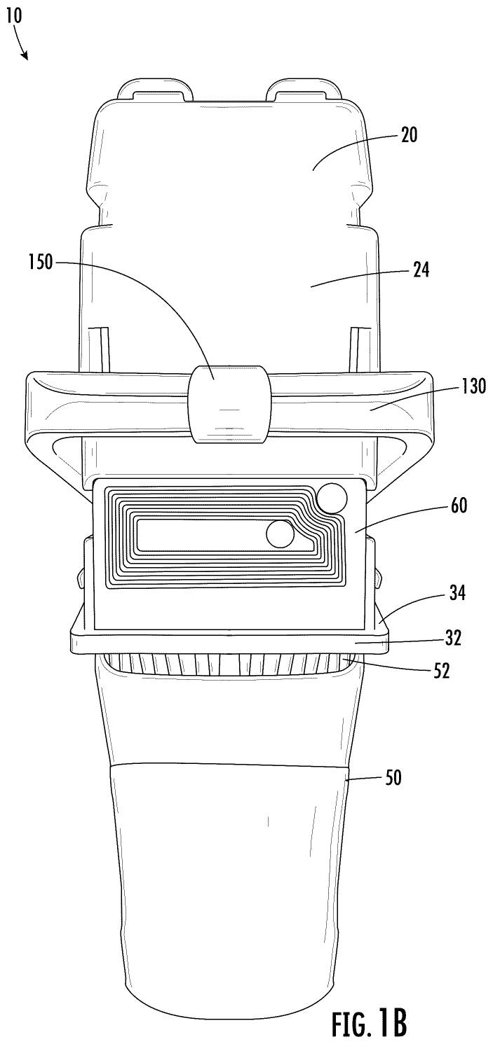

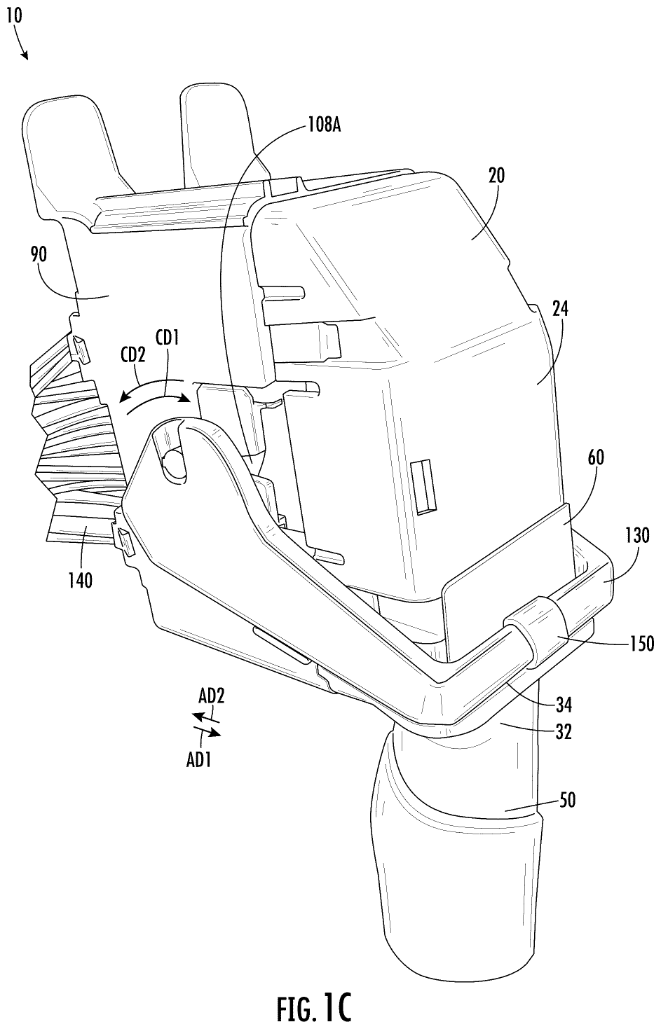

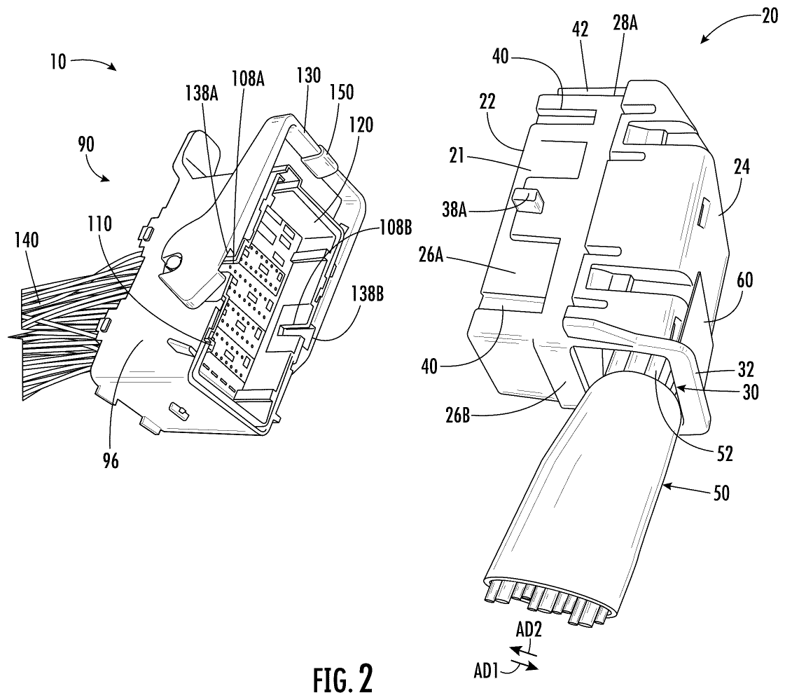

Adverting now to the figures, FIG. 1A is a front perspective view of electrical connection assembly 10 in an unconnected state. FIG. 1B is a front elevational view of electrical connection assembly 10, in an unconnected state. FIG. 1C is a front perspective view of electrical connection assembly 10, in a connected state. FIG. 2 is an exploded front perspective view of electrical connection assembly 10. Electrical connection assembly 10 comprises component or connector 20 and component or connector 90. In an exemplary embodiment, electrical connection assembly 10 further comprises locking handle 130 connected to one of the connector 20 and connector 90. Locking handle 130 is operatively arranged to lock connector 20 to connector 90. In an exemplary embodiment, electrical connection assembly 10 further comprises RFID assembly 60. Electrical connection assembly 10 is operatively arranged to connect electrical conductors or data cables (e.g., coaxial cable, fiber optic cable, twisted pair, etc.) for the transfer of power and/or data between circuits. For example, electrical connection assembly 10 is operatively arranged to connect wires 52 to wires 140.

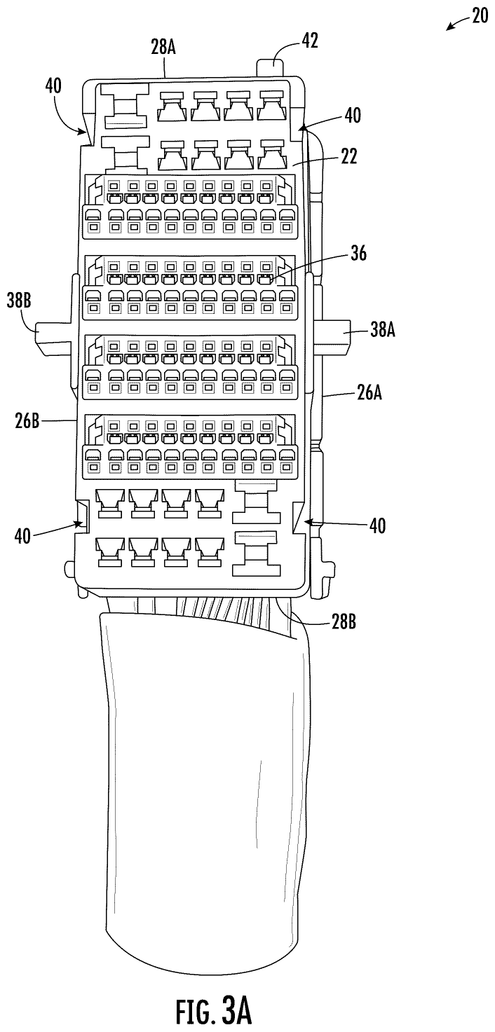

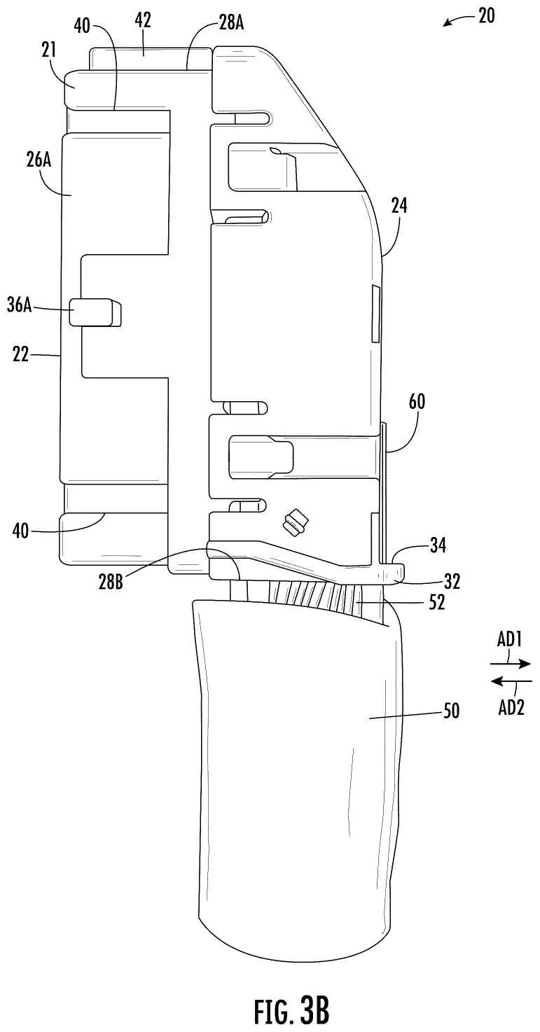

FIG. 3A is a rear elevational view of connector 20. FIG. 3B is a side elevational view of connector 20. In an exemplary embodiment, and as shown, connector 20 is a male connector and connector 90 is a female connector. In such exemplary embodiment, connector 20 comprises engaging portion 21 arranged to engage hole 114 of connector 90. However, it should be appreciated that in an exemplary embodiment connector 90 is a male connector and connector 20 is a female connector. Connector 20 comprises rear surface 22, front surface 24, side surface 26A, side surface 26B, top surface 28A, and bottom surface 28B. In an exemplary embodiment, rear surface 22 is a substantially planar surface and operatively arranged to engage connector 90. Specifically, surface 22 is arranged to engage surface 124 of insert 120, as will be described in greater detail below. Rear surface 22 comprises a plurality of holes or ports or sockets 36 operatively arranged to engage conductors or terminals 102. Each of holes 36 comprises a terminal connected to one of wires 52. Thus, when one of terminals 102 fully engages one of holes 36, an electrical or data connection is completed.

In an exemplary embodiment, front surface 24 is connected to rear surface 22 by at least one of side surface 26A, side surface 26B, top surface 28A, and bottom surface 28B. Front surface 24 is operatively arranged to engage or be in close proximity to locking handle 130 when locking handle 130 is in the deployed position (see FIG. 1C). In an exemplary embodiment, connector 20 further comprises lip or flange 32 extending from front surface 24, generally in axial direction AD1. Flange 32 comprises surface 34. In an exemplary embodiment, surface 34 is arranged perpendicular to front surface 24. Surface 34 is operatively arranged to engage locking handle 130 when locking handle 130 is in the deployed position, as will be described in greater detail below.

Connector 20 further comprises hole 30. In an exemplary embodiment, hole 30 is arranged in bottom surface 28B. Wires 52 extend through hole 30 to engage with holes 36. In an exemplary embodiment, wires 52 may be enclosed by conduit 50. In an exemplary embodiment, connector 20 further comprises one or more locking protrusions, for example, locking protrusions 38A-38B. Locking protrusion 38A extends from side surface 26A and is arranged proximate to rear surface 22. Locking protrusion 38B extends from side surface 26B and is arranged proximate to rear surface 22. Locking protrusions 38A-38B are operatively arranged to engage holes 108A-108B of connector 90 and grooves 138A-138B of locking handle 130, respectively, to secure connector 20 to connector 90, as will be described in greater detail below.

In an exemplary embodiment, connector 20 further comprises projection 42 extending from top surface 28A. Projection 42 is operatively arranged to engage groove 106 of connector 90 to maintain alignment between connector 20 and connector 90 during assembly. In an exemplary embodiment, connector 20 further comprises one or more channels 40 arranged in side surface 26A and/or side surface 26B. Channels 40 are operatively arranged to maintain alignment between connector 20 and connector 90 during assembly.

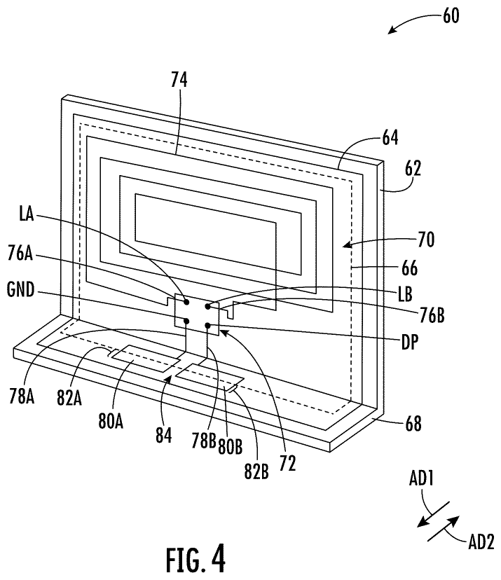

FIG. 4 is a perspective view of RFID assembly 60. RFID assembly 60 generally comprises at least one layer (e.g., adhesive layer 62 and/or layer 64), RFID tag 70, and at least one contact (e.g., contact 80A and/or contact 80B). In an exemplary embodiment, RFID assembly 60 is a RFID label that is connected to a connector or component, wherein the component is arranged to be connected to another component.

Adhesive layer 62 is operatively arranged to be secured to connector 20. In some embodiments, adhesive layer 62 secures layer 64 and/or contacts 80A and 80B to connector 20. It should be appreciated that layer 64 need not be connected to connector 20 via adhesives (i.e., adhesive layer 62), but rather can be connected and/or applied using any other suitable means, for example, string, tape, hook and loop fastener, solder, welding, etc. In some embodiments, adhesive layer 62 is connected to front surface 24 to secure RFID assembly 60 to connector 20. In an exemplary embodiment, adhesive layer 62 is connected to front surface 24 and surface 34 to secure RFID assembly 60 to connector 20, and thus comprises bent or folded portion 68. In an exemplary embodiment, bent portion 68 is engaged with surface 34.

RFID assembly 60 may further comprise layer 64. Layer 64 is connected to the top surface of adhesive layer 62 and is operatively arranged as a platform or base for RFID tag 70 and contacts 80A-B. In an exemplary embodiment, layer 64 comprises ferrite. In an exemplary embodiment, RFID tag 70 and contacts 80A-B are connected directly to the top surface of adhesive layer 62, without the need for layer 64. In an exemplary embodiment, RFID tag 70 and contacts 80A-B are connected directly to connector body 20, specifically front surface 24 and surface 34, respectively, without the need for adhesive layer 62 or layer 64. In an exemplary embodiment, RFID assembly 60 further comprises layer 66. Layer 66 is operatively arranged to cover and protect RFID tag 70. As shown in FIG. 4, layer 66 completely covers RFID tag 70 and at least partially covers contacts 80A and 80B. However, it is required that at least a portion of contacts 80A and 80B are exposed, for example, exposed portions 82A and 82B, such that they are capable of engaging conductive contact assembly 150, 250, 350, 450, as will be described in greater detail below. In an exemplary embodiment, protective layer 66 extends at least partially onto bent portion 68.

RFID tag 70 comprises integrated circuit (IC) or chip 72 and antenna 74. In an exemplary embodiment, RFID tag 70 comprises a passive RFID tag. In an exemplary embodiment, RFID tag 70 comprises an active RFID tag (and further comprises a power source). In an exemplary embodiment, RFID tag 70 comprises a semi-passive RFID tag. In some embodiments, RFID tag 70 is preprogrammed such that it transmits information, for example, a unique identification (UID) number, the state of RFID assembly 60 (i.e., open or closed), etc. Antenna 74 is connected at a first end to IC 72 at antenna radio-frequency (RF) input LA, and at a second end to IC 72 at antenna RF input LB, via conductors 76A and 76B, respectively. RFID tag 70 is further connected to contact 80A and contact 80B. Specifically, conductor 78A connects contact 80A with IC 72 at ground pin GND and conductor 78B connects contact 80B with IC 72 at detector pin DP.

Contact 80A is separated from contact 80B by gap 84. In an exemplary embodiment, and as shown, contacts 80A and 80B are arranged on bent portion 68, and specifically on surface 34 of flange 32. Contacts 80A and 80B are operatively arranged to engage with conductive contact assembly 150, 250, 350, 450. In an exemplary embodiment, contacts 80A and 80B are electrical conductors. When connector 20 is properly secured to connector 90, locking handle 130 is displaced in circumferential direction CD1 from a retracted position to a deployed position, which locks connector 20 to connector 90. When electrical connection assembly 10 is fully connected, conductive contact assembly 150, 250, 350, 450 engages contacts 80A and 80B. For example, and as shown in FIG. 1C, conductive contact assembly 150 is engaged with contact 80A and contact 80B. In an exemplary embodiment, conductive contact assembly 150, 250, 350, 450 comprises an electrically conductive material (e.g., metal). As such, conductive contact assembly 150, 250, 350, 450 completes the circuit between contacts 80A-B and IC 72 and causes RFID tag 70 to become enabled (i.e., RFID tag 70 is capable of being powered by an electromagnetic field generated by an external device (not shown)) or switch to a closed state (from an open state). Prior to completion of the circuit, namely, electrically connecting contact 80B directly with contact 80A, RFID tag 70 is not enabled (i.e., RFID tag 70 is not capable of being powered by an electromagnetic field generated by the external device) or in some embodiments, it indicates an open status.

When the circuit is completed (i.e., conductive contact assembly 150, 250, 350, 450 directly connects contact 80A and contact 80B), an external device such as a RFID reader (not shown) will detect that RFID tag 70 is enabled, or in a closed state, thereby indicating that electrical connection assembly 10 is properly connected. Put another way, when RFID tag 70 is enabled, the RFID reader will identify that RFID tag 70 exists and thus determine that electrical connection assembly 10 is properly connected. When the circuit is not completed (i.e., contact 80A is not directly connected to contact 80B), the RFID reader will not detect an enabled RFID tag 70 thereby indicating that electrical connection assembly 10 is not properly connected. Put in yet another way, when RFID tag 70 is disabled, the RFID reader will not identify that RFID tag 70 exists and thus determine that electrical connection assembly 10 is not properly connected.

In an exemplary embodiment, RFID tag 70 is always enabled and can be detected and read by a RFID reader regardless of whether contacts 80A and 80B are connected. In such exemplary embodiment, when contacts 80A and 80B are not directly connected, for example via conductive contact assembly 150, 250, 350, 450, RFID tag 70 is capable of transmitting, to a RFID reader, certain information. Such information may include, but is not limited to, a UID number (e.g., for the RFID tag, connector, circuits, conduits, wires, etc.), size number, model number, serial number, status of RFID tag 70 (i.e., open or closed), uniform resource locator (URL), station identification (i.e., manufacturing LOT number), date/time stamp, description, etc. Put another way, independent of whether contacts 80A and 80B are connected, RFID tag 70 will always transmit certain data (e.g., a UID number, a status, etc.) provided it is properly functioning. Thus, in an exemplary embodiment, RFID tag 70 is preprogrammed to always transmit at least a UID number and a status (i.e., open or closed), for example, using hexadecimal data or a value. This is important because it allows the user to scan a given RFID tag to determine if it is properly functioning (i.e., if the RFID tag is properly transmitting data then it is properly functioning) as well as to determine its current state (i.e., open or closed). When contacts 80A and 80B are connected, for example, via conductive contact assembly 150, 250, 350, 450, RFID tag 70 transmits data indicating a closed status. In some embodiments, RFID tag 70 indicates a first value (e.g., a first hexadecimal value) for an open state and a second value (e.g., second hexadecimal value) for a closed state, the second value being different from the first value. It should be appreciated that RFID tag 70 may include any programming suitable for indicating that it is properly functioning and a differentiation between an open state and a closed state, and that the present disclosure should not be limited to just the use of the hexadecimal system.

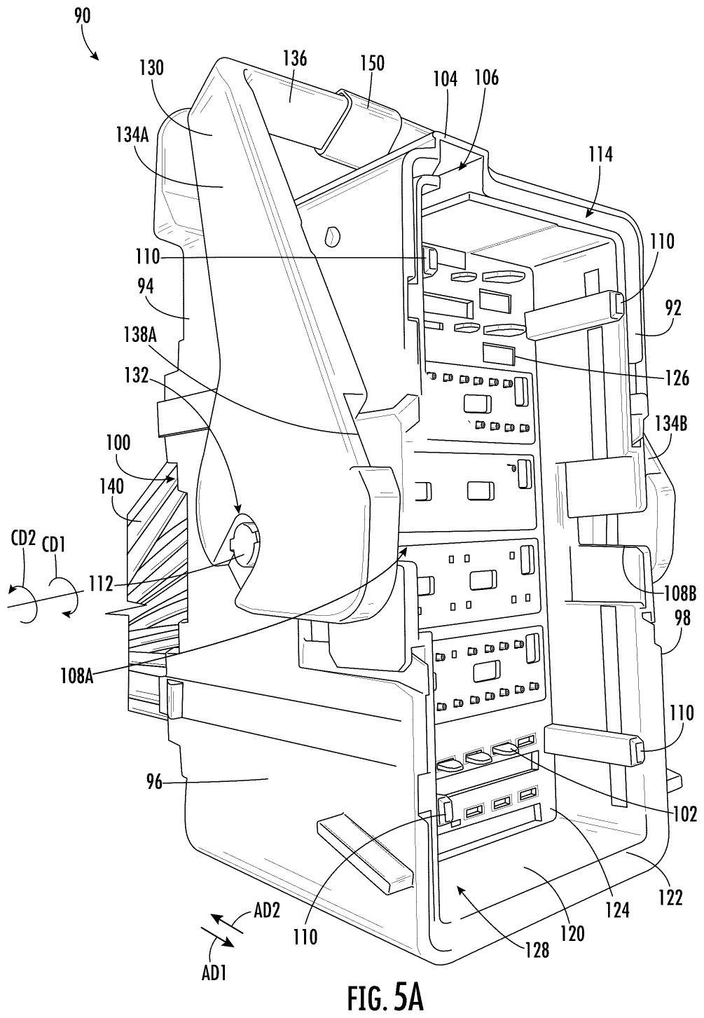

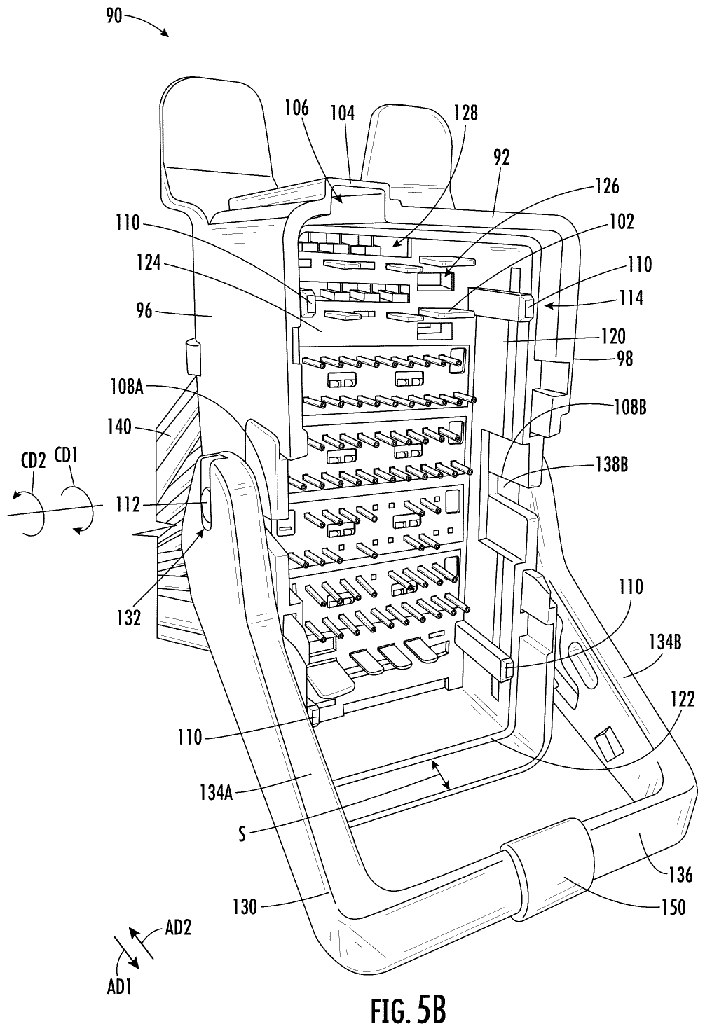

FIG. 5A is a front perspective view of connector 90, with locking handle 130 in a retracted position. FIG. 5B is a front perspective view of connector 90, with locking handle 130 in a deployed position. Connector 90 comprises front surface 92, rear surface 94, side surface 96, and side surface 98. Connector 90 comprises hole 114 which extends from front surface 92 in axial direction AD2. Front surface 94 comprises a plurality of holes 100. Wires 140 extend through holes 100 and connect to a respective conductor or terminal 102. In an exemplary embodiment, terminals 102 are rigid and are arranged to extend through holes 126 in insert 120 to engage holes 36 in connector 20, as will be described in greater detail below.

In an exemplary embodiment, connector 90 comprises protrusion 104 extending from a surface thereof, for example the top surface of connector 90. Protrusion 104 forms channel 106, which is arranged to engage projection 42 to maintain alignment of connector 20 and connector 90 during assembly. In an exemplary embodiment, connector 90 comprises one or more holes, for example, holes 108A-108B. Holes 108A-108B are operatively arranged to engage protrusions 38A-38B, respectively. Hole 108A is a through-hole extending through side surface 96. In an exemplary embodiment, hole 108A extends through insert 120. Hole 108B is a through-hole extending through side surface 98. In an exemplary embodiment, hole 108B extends through insert 120. Protrusions 38A-38B are arranged to reside in holes 108A-108B, and be locked therein by locking handle 130, in the connected state. In an exemplary embodiment, connector 90 further comprises one or more projections 110. Projections 110 are operatively arranged to engage channels 40 to maintain alignment of connector 20 with connector 90 during assembly. In an exemplary embodiment, projections 110 are arranged in hole 114 and/or on insert 120.

Insert 120 is slidably or translationally connected to connector 90. Specifically, insert 120 is arranged in hole 114 and arranged to be displaced in axial direction AD1 and axial direction AD2 with respect to connector 90. Insert 120 comprises front surface 122, surface 124, and hole 126. Hole 126 extends from front surface 122 in axial direction AD2 and forms surface 124. As such, surface 124 is recessed from front surface 122. Surface 124 comprises a plurality of holes 126 which slidingly engage terminals 102.

Insert 120 is connected to locking handle 130 such that, as locking handle 130 is circumferentially displaced with respect to connector 90 insert 120 is axially displaced with respect to connector 90. For example, as locking handle 130 is displaced in circumferential direction CD1 with respect to connector 90, insert 120 is displaced in axial direction AD2 with respect to connector 90. This allows terminals 102 to further protrude from surface 124. Such circumferential displacement of locking handle 130 also pulls engaging portion 21 further into connector 90, as will be described in greater detail below. As locking handle 130 is displaced in circumferential direction CD2 with respect to connector 90, insert 120 is displaced in axial direction AD1 with respect to connector 90. This action protects terminals 102 by allowing none or only a small portion of terminals 102 to protrude from surface 124 in axial direction AD1.

For example, in the retracted state of locking handle 130 shown in FIG. 5A, terminals 102 protrude from surface 124 in axial direction AD1 a first amount, and in the deployed state of locking handle 130 shown in FIG. 5B, terminals 102 protrude from surface 124 in axial direction AD1 a second amount, the second amount being greater than the first amount. This is a result of the axial displacement of insert 120. Thus, in the retracted state of locking handle 130 shown in FIG. 5A, front surface 122 of insert is substantially aligned with front surface 92 of connector 90. In the deployed state of locking handle 130 shown in FIG. 5B, front surface 122 is separated from front surface 92 by space S. Thus, terminals 102 remain fixed in relation to connector 90 and insert 120 displaces with respect thereto. In an exemplary embodiment, connector 90 and insert 120 comprise at least one protrusion and at least one channel to maintain alignment during axial displacement of insert 120 with respect to connector 90.

Locking handle 130 is pivotably connected to connector 90. In an exemplary embodiment, connector 90 comprises one or more pivot connections or pins 112 and locking handle 130 comprises one or more pivot connections or holes 132 engaged with pin 112. However, it should be appreciated that locking handle 130 may comprise the pins and connector 90 may comprise the holes. Locking handle 130 comprises at least one arm, for example arms 134A-134B, pivotably connected to connector 90. Arm 134A is pivotably connected at a proximal end to side surface 96 and arm 134B is pivotably connected at a proximal end to side surface 98. Strut 136 is connected to and extends between the distal ends of arms 134A-134B.

Arm 134A comprises groove 138A operatively arranged to engage protrusion 38A of connector 20. As best shown in FIG. 1A, in a retracted state of handle 30, groove 138A and hole 108A are aligned, which allows protrusion 38A to be inserted therein. Locking handle 130 can then be displaced in circumferential direction CD1 wherein a surface of groove 138A engages protrusion 38A pulling it further into hole 108A, in axial direction AD2, and ultimately locking it therein as shown in FIG. 1C. Similarly, arm 134B comprises groove 138B operatively arranged to engage protrusion 38B of connector 20. In the retracted state of handle 30, groove 138B and hole 108B are aligned, which allows protrusion 38B to be inserted therein. Locking handle 130 can then be displaced in circumferential direction CD1 wherein a surface of groove 138B engages protrusion 38B pulling it further into hole 108B, in axial direction AD2, and ultimately locking it therein.

Locking handle 130 further comprises a conductive contact assembly, for example, conductive contact assembly 150, 250, 350, 450 operatively arranged to engage surface 134, and specifically contacts 80A-80B, to verify a secure connection. For example, in an exemplary embodiment, locking handle 130 comprises conductive contact assembly 150, for example a strip of foil tape. Conductive contact assembly 150 comprises a tubular conductor at least partially circumscribing (i.e., wrapping around) strut 136. When locking handle 130 is in the deployed position, as shown in FIG. 1C, conductive contact assembly 150 engages both contacts 80A-80B (for example arranged on surface 34), and the circuit of RFID assembly 60 is completed or closed, indicating a connected state of electrical connection assembly 10, as previously described. When locking handle 130 is not in the deployed position, for example as shown in FIGS. 1A-1B, conductive contact assembly 150 is not engaged with contacts 80A-80B, and the circuit of RFID assembly 60 remains incomplete or open, indicating an unconnected state of electrical connection assembly 10.

Thus, locking handle 30 comprises a number of functions: 1) to displace insert 120 axially with respect to connector 90, thus exposing terminals 102 to a greater or lesser degree; 2) to engage protrusions 38A-38B to pull them, and connector 20, further into connector 90; 3) to secure protrusions 38A-38B in holes 108A-108B and lock connector 20 to connector 90; and 4) to engage RFID assembly 60 to verify a suitable connection.

To assemble electrical connection assembly 10, locking handle 130 is displaced to the retracted state, for example as shown in FIG. 1A. Engaging portion 21 of connector 20 is inserted into holes 114 and 128 with protrusions 38A-38B aligned with holes 108A-108B and grooves 138A-138B, respectively. Additionally, channels 40 are aligned with projections 110 and projection 42 is aligned with channel 106. When fully inserted, rear surface 22 is engaged with and/or arranged proximate to and/or abutting against surface 124. Locking handle 130 is then displaced in circumferential direction CD1, which as previously described, displaces insert 120 in axial direction AD2 with respect to connector 90, pulls protrusions 38A-38B and thus engaging portion 21 further into connector 90 in axial direction AD2, and causes terminals 102 to engage holes 36. When locking handle 130 is in the deployed position, for example as shown in FIG. 1C, terminals 102 are fully engaged with holes 36 thereby resulting in connection between wires 140 and wires 52, protrusions 38A-38B are locked in holes 108A-108B, conductive contact assembly 150, 250, 350, 450 is engaged with contacts 80A-80B, and RFID assembly 60 indicates a connected state (see FIG. 1C). To disassemble electrical connection assembly 10, locking handle 130 is displaced in circumferential direction CD2 back to the retracted state and connector 90 is removed from connector 20.

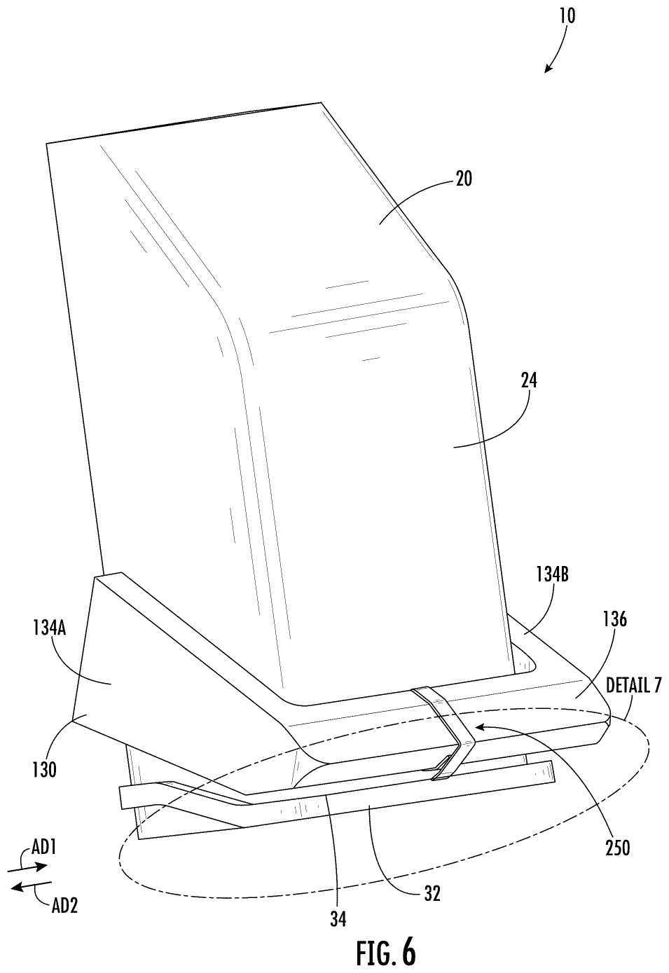

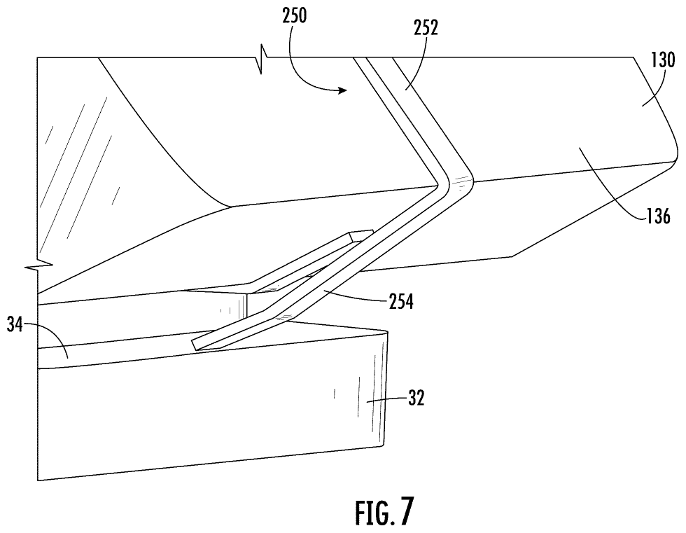

FIG. 6 is a partial front perspective view of electrical connection assembly 10, in a connected state. FIG. 7 is a detail view of electrical connection assembly 10 taken generally along Detail 7 in FIG. 6. In an exemplary embodiment, locking handle 130 comprises conductive contact assembly 250. Conductive contact assembly 250 comprises portion 252 and portion or tab 254. Portion 252 at least partially circumscribes strut 136 and is arranged to connect conductive contact assembly 250 to handle 130. Tab 254 is connected to portion 252 and extends radially outward from strut 136. In an exemplary embodiment, the radially outward arrangement of tab 254 bridges any gap between locking handle 130 and flange 32 in the connected state. When locking handle 130 is in the deployed position, conductive contact assembly 250, and specifically radially outward extending tab 254, engages both contacts 80A-80B (for example arranged on surface 34), and the circuit of RFID assembly 60 is completed or closed, indicating a connected state of electrical connection assembly 10, as previously described. When locking handle 130 is not in the deployed position, conductive contact assembly 250 is not engaged with contacts 80A-80B, and the circuit of RFID assembly 60 remains incomplete or open, indicating an unconnected state of electrical connection assembly 10.

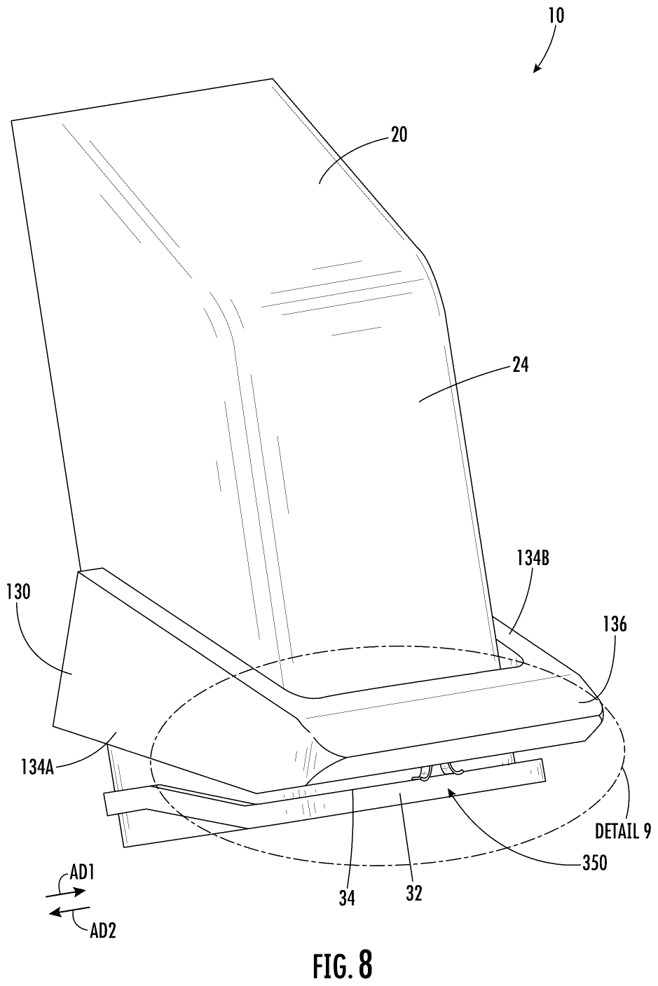

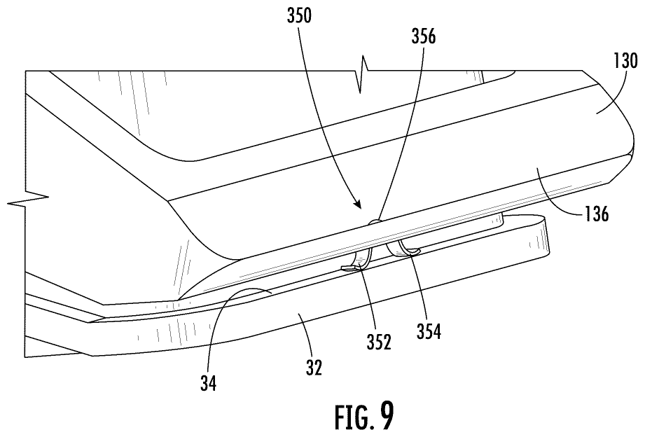

FIG. 8 is a partial front perspective view of electrical connection assembly 10, in a connected state. FIG. 9 is a detail view of electrical connection assembly 10 taken generally along Detail 9 in FIG. 8. In an exemplary embodiment, locking handle 130 comprises conductive contact assembly 350. Conductive contact assembly 350 comprises portion or tab 352, portion or tab 354, and portion 356. Portion 352 is a tab extending radially outward from strut 136. In an exemplary embodiment, portion 352 is a curvilinear tab. Portion 354 is a tab extending radially outward from strut 136. In an exemplary embodiment, portion 354 is a curvilinear tab. In an exemplary embodiment, portion 354 is spaced apart from portion 352 along strut 136. Portion 354 is electrically connected to portion 352 via portion 356. Portion 356 is embedded in strut 136. In an exemplary embodiment, conductive contact assembly 350 is molded into locking handle 130. In an exemplary embodiment, conductive contact assembly 350 may resemble a U-shape. The radially outward arrangement of tabs 352 and 354 bridges any gap between locking handle 130 and flange 32 in the connected state. When locking handle 130 is in the deployed position, conductive contact assembly 350, and specifically radially outward extending tabs 352 and 354, engages both contacts 80A-80B (for example arranged on surface 34), and the circuit of RFID assembly 60 is completed or closed, indicating a connected state of electrical connection assembly 10, as previously described. When locking handle 130 is not in the deployed position, conductive contact assembly 350 is not engaged with contacts 80A-80B, and the circuit of RFID assembly 60 remains incomplete or open, indicating an unconnected state of electrical connection assembly 10.

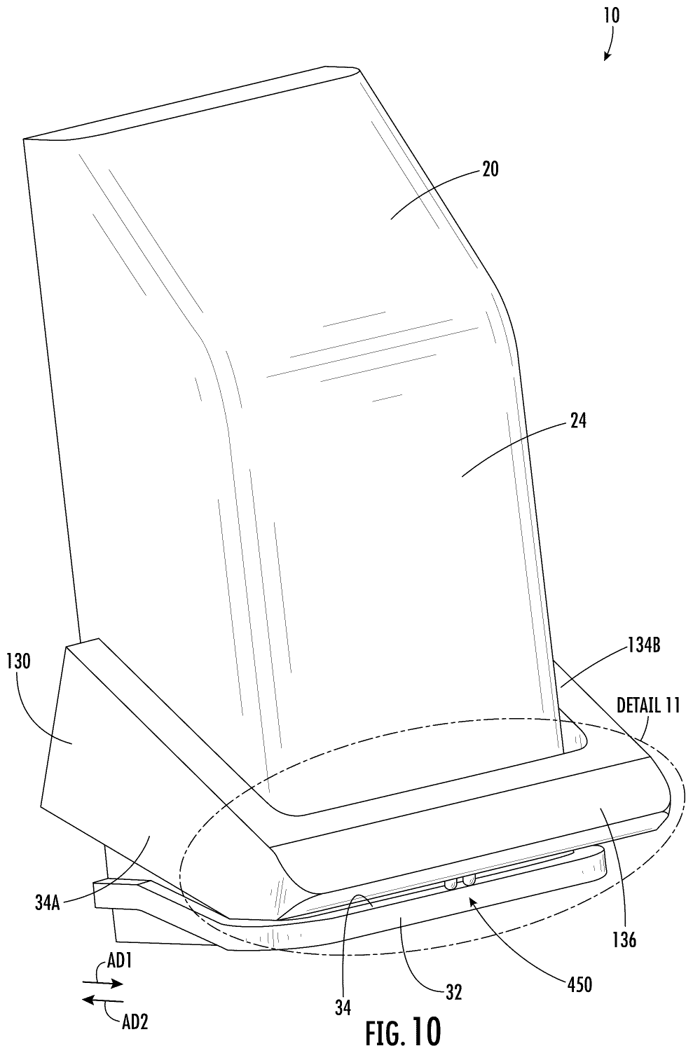

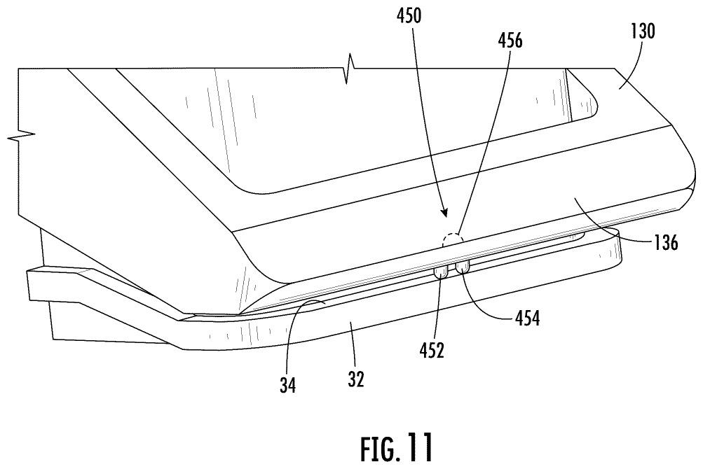

FIG. 10 is a partial front perspective view of electrical connection assembly 10, in a connected state. FIG. 11 is a detail view of electrical connection assembly taken generally along Detail 11 in FIG. 10. In an exemplary embodiment, locking handle 130 comprises conductive contact assembly 450. Conductive contact assembly 450 comprises portion or cylindrical rod 452, portion or cylindrical rod 454, and portion 456. Portion 452 is a cylindrical terminal extending radially outward from strut 136. Portion 454 is a cylindrical terminal extending radially outward from strut 136. In an exemplary embodiment, portion 454 is spaced apart from portion 452 along strut 136. Portion 454 is electrically connected to portion 452 via portion 456. Portion 456 is embedded in strut 136. In an exemplary embodiment, conductive contact assembly 450 is molded into locking handle 130. In an exemplary embodiment, conductive contact assembly 450 may resemble a U-shape. The radially outward arrangement of tabs 452 and 454 bridges any gap between locking handle 130 and flange 32 in the connected state. When locking handle 130 is in the deployed position, conductive contact assembly 450, and specifically radially outward extending terminals or rods 452 and 454, engages both contacts 80A-80B (for example arranged on surface 34), and the circuit of RFID assembly 60 is completed or closed, indicating a connected state of electrical connection assembly 10, as previously described. When locking handle 130 is not in the deployed position, conductive contact assembly 450 is not engaged with contacts 80A-80B, and the circuit of RFID assembly 60 remains incomplete or open, indicating an unconnected state of electrical connection assembly 10.

It will be appreciated that various aspects of the disclosure above and other features and functions, or alternatives thereof, may be desirably combined into many other different systems or applications. Various presently unforeseen or unanticipated alternatives, modifications, variations, or improvements therein may be subsequently made by those skilled in the art which are also intended to be encompassed by the following claims.

### REFERENCE NUMERALS

10 Electrical connection assembly
20 Connector or component
21 Engaging portion
22 Rear surface
24 Front surface
26A Side surface
26B Side surface
28A Top surface
28B Bottom surface
30 Hole
32 Lip or flange
34 Surface
36 Holes
38A Protrusion
38B Protrusion
40 Channel(s)
42 Projection
50 Conduit
52 Wires or lines
60 RFID assembly (or label)
62 Adhesive layer
64 Layer
66 Layer
68 Bent or folded portion
70 RFID tag
72 Integrated circuit (or chip)
74 Antenna
76A Conductor
76B Conductor
78A Conductor
78B Conductor
80A Contact
80B Contact
82A Exposed portion
82B Exposed portion
84 Gap
90 Connector or component
92 Front surface
94 Rear surface
96 Side surface
98 Side surface
100 Holes
102 Conductor or terminal
104 Protrusion
106 Channel
108A Hole
108B Hole
110 Projections
112 Pivot connection or pin
114 Hole
120 Insert
122 Front surface
124 Surface
126 Holes
128 Hole
130 Locking handle
132 Pivot connection or hole
134A Arm
134B Arm
136 Strut
138A Groove
138B Groove
140 Wires or lines
150 Conductive contact assembly
250 Conductive contact assembly
252 Portion
254 Portion
350 Conductive contact assembly
352 Portion
354 Portion
356 Portion
450 Conductive contact assembly
452 Portion
454 Portion
456 Portion
AD1 Axial direction
AD2 Axial direction
CD1 Circumferential direction
CD2 Circumferential direction
S Space

What is claimed is:

1. An electrical connection assembly, comprising:
a first connector including:
an engaging portion;
a first surface comprising a plurality of sockets; and
a first plurality of wires connected to the plurality of sockets;
a second connector including:
a plurality of terminals; and
a second plurality of wires connected to the plurality of terminals;
a radio-frequency identification (RFID) assembly connected to one of the first connector and the second connector; and
a locking handle operatively arranged to lock the second connector to the first connector;
wherein:
in an unconnected state the locking handle is not engaged with the RFID assembly; and
in a connected state the locking handle is engaged with the RFID assembly.

2. The electrical connection assembly as recited in claim 1, wherein the RFID assembly comprises:
a RFID tag; and
at least one contact electrically connected to the RFID tag.

3. The electrical connection assembly as recited in claim 2, wherein the at least one contact comprises a first contact and a second contact, the second contact separated from the first contact to form an open state of the RFID assembly.

4. The electrical connection assembly as recited in claim 3, wherein in the connected state, the first contact is electrically connected to the second contact.

5. The electrical connection assembly as recited in claim 3, wherein the locking handle comprises a conductive contact assembly operatively arranged to, in the connected state, electrically connect the first contact to the second contact.

6. The electrical connection assembly as recited in claim 5, wherein the conductive contact assembly comprises a conductor at least partially circumscribing the locking handle.

7. The electrical connection assembly as recited in claim 6, wherein the conductive contact further comprises a tab extending radially outward from the conductor.

8. The electrical connection assembly as recited in claim 5, wherein the conductive contact assembly comprises:
a first conductor portion extending radially outward from the locking handle and operatively arranged to engage the first contact; and
a second conductor portion extending radially outward from the locking handle and operatively arranged to engage the second contact.

9. The electrical connection assembly as recited in claim 8, wherein the conductive contact assembly further comprises a third conductor portion connecting the first conductor portion and the second conducting portion, the third conductor portion being embedded in the locking handle.

10. The electrical connection assembly as recited in claim 8, wherein at least one of the first conductor portion and the second conductor portion comprises a cylindrical rod.

11. The electrical connection assembly as recited in claim 8, wherein at least one of the first conductor portion and the second conductor portion comprises a curvilinear tab.

12. The electrical connection assembly as recited in claim 2, wherein:
the first connector comprises a first surface and a flange extending from the first surface;
the RFID tag is arranged on the first surface; and
the at least one contact is arranged on the flange.

13. The electrical connection assembly as recited in claim 12, wherein the flange is perpendicular to the first surface.

14. The electrical connection assembly as recited in claim 1, wherein:
the RFID assembly is arranged on the first connector; and
the locking handle is pivotably connected to the second connector.

15. The electrical connection assembly as recited in claim 1, wherein:
the RFID tag comprises an antenna;
in an open state of the RFID tag, the antenna circuit is open; and
in a closed state of the RFID tag, the antenna circuit is closed.

16. An electrical connection assembly, comprising:
a first connector including:
an engaging portion;
a first surface comprising a plurality of sockets; and
a first plurality of wires connected to the plurality of sockets;
a second connector including:
a hole operatively arranged to engage the engaging portion;
a plurality of terminals; and
a second plurality of wires connected to the plurality of terminals;
a radio-frequency identification (RFID) assembly connected to one of the first connector and the second connector, the RFID assembly comprising:
a RFID tag;
a first contact electrically connected to the RFID tag; and
a second contact electrically connected to the RFID tag and spaced apart from the first contact; and
a locking handle pivotably connected to the other of the first connector and the second connector, the locking handle operatively arranged to lock the second connector to the first connector;
wherein:
in an unconnected state the locking handle is not engaged with the first contact and the second contact; and
in a connected state the locking handle is engaged with the first contact and the second contact.

17. The electrical connection assembly as recited in claim 16, wherein the locking handle comprises a conductive contact assembly operatively arranged to, in the connected state, electrically connect the first contact to the second contact.

18. The electrical connection assembly as recited in claim 17, wherein the conductive contact assembly comprises a conductor at least partially circumscribing the locking handle.

19. The electrical connection assembly as recited in claim 18, wherein the conductive contact further comprises a tab extending radially outward from the conductor.

20. The electrical connection assembly as recited in claim 15, wherein the conductive contact assembly comprises:
a first conductor portion extending radially outward from the locking handle and operatively arranged to engage the first contact; and
a second conductor portion extending radially outward from the locking handle and operatively arranged to engage the second contact.
